(19) United States
(12) Patent Application Publication
(10) Pub. No.: US 2008/0076047 A1
(43) Pub. Date: Mar. 27, 2008

(54) Method of forming image contour for predicting semiconductor device pattern

(75) Inventors: Yong-jin Chun, Yuseong-gu (KR); Doo-youl Lee, Seongnam-si (KR); Moon-hyun Yoo, Suwon-si (KR); Suk-joo Lee, Yongin-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/589,026

(22) Filed: Oct. 27, 2006

(30) Foreign Application Priority Data
Sep. 26, 2006 (KR) 10-2006-0093730

(51) Int. Cl. G03C 5/00

(52) U.S. Cl. 430/30

(57) ABSTRACT

A method of forming an image contour for predicting a pattern image formed on a wafer from a layout of a semiconductor device includes: forming a basic layout for a semiconductor device; performing an optical proximity effect correction (OPC) on the basic layout to form an OPC layout; defining nonlinear regions and linear regions of the basic layout; emulating the nonlinear regions of the basic layout using the OPC layout to form an image contour of the nonlinear regions; determining the linear regions of the basic layout as an image contour of the linear regions; and combining the image contour of the nonlinear regions and image contour of the linear regions to form an image contour of the entire semiconductor device.

### CROSS-REFERENCE TO RELATED PATENT APPLICATION

This application claims priority under 35 U.S.C. 119 to Korean Patent Application No. 10-2006-0093730, filed on Sep. 26, 2006, in the Korean Intellectual Property Office, the disclosure of which is incorporated herein in its entirety by reference.

### BACKGROUND OF THE INVENTION

1. Field of the Invention

The present invention relates to a semiconductor layout for forming a semiconductor device, and more particularly, to a method of forming an image contour for predicting a pattern formed on a semiconductor wafer from a layout.

2. Description of the Related Art

Electronic circuits are commonly formed as patterns to be engraved in semiconductor wafers using semiconductor manufacturing processes. Such patterns are referred to as a circuit layout. If the sizes of the patterns to be formed are sufficiently large, patterns having the same shapes as layouts are formed on photolithography masks, which are then placed in an exposing apparatus to expose the patterns. In this manner, mask patterns that are equal to the layout can be transferred to semiconductor wafers.

However, with ever-increasing integration of semiconductor devices, the corresponding patterns continue to become rapidly reduced in size. Thus, it is increasingly difficult to transfer mask patterns to wafers. This is primarily due to the diffraction of exposure light. In other words, an image formed by an exposure becomes distorted due to interference between near fields in a micro-pattern area in which patterns are too close to each other. Thus, the patterns of photo masks are not accurately transferred due to optical phenomena such as the optical proximity effect. For this reason, optical proximity correction (OPC) is performed on a layout prior to exposure.

As the sizes of the patterns are reduced beyond the resolution limit of photolithography, there has been suggested a double patterning process in which first hard mask patterns are formed within the resolution limit, and then second hard mask patterns are formed between the first hard mask patterns. In particular, in a self aligned double patterning (SADP) process as a kind of double patterning process, second hard mask patterns are formed from first hard mask patterns using a self alignment method. For example, first hard mask patterns are formed of polysilicion using photoresist patterns. Also, a silicon oxide layer and a polysilicion layer are sequentially filled between the first hard mask patterns and then etched back to expose the first hard mask patterns. Next, the silicon oxide layer exposed by etch back is selectively removed. The places where the silicon oxide layer has been removed becomes the space between the first hard mask patterns and the second hard mask patterns. The second hard mask patterns are formed of stacks of the silicon oxide layer and the polysilicon layer between the first hard mask patterns. As a result, the first and second hard mask patterns may constitute hard mask patterns having about one-half the pitch of that of the first hard mask patterns. Photo masks for forming patterns using SADP are required only for formation of the first hard mask patterns.

In the process of photo mask formation, an OPC layout is formed from a layout obtained from the circuit design, and an emulation process using the OPC layout is performed to predict an image of a substantial pattern. An image contour is formed through the emulation, and the image contour is used to predict a pattern image formed when an OPC layout is transferred to a wafer through masks using an exposure process. An image of second hard mask patterns can be predicted based on an image contour of first hard mask patterns obtained through emulation. An OPC layout can be corrected based on the image contour of first hard mask patterns. And based on the predicted image of the second hard mask patterns.

However, a large amount of time is required to emulate a layout of an entire chip so as to form an image contour. If a large amount of time is required to form an image contour of first hard mask patterns, a large amount of time is required to predict second hard mask patterns, to correct the layout, and to form substantial photo masks. Thus, the overall turnaround time (TAT) required for product production is increased.

### SUMMARY OF THE INVENTION

The present invention provides a method of forming an image contour for effectively predicting an image of a wafer pattern of an entire chip from a layout of a semiconductor device within a relatively short time period.

According to an aspect of the present invention, there is provided a method of forming an image contour, including: forming a basic layout for a semiconductor device; performing an optical proximity effect correction (OPC) on the basic layout to form an OPC layout; defining nonlinear regions and linear regions of the basic layout; emulating the nonlinear regions of the basic layout using the OPC layout to form an image contour of the nonlinear regions; determining the linear regions of the basic layout as an image contour of the linear regions; and combining the image contour of the nonlinear regions and image contour of the linear regions to form an image contour of the entire semiconductor device.

The semiconductor device can be a flash memory device. The image contour of the semiconductor device can include a gate pattern.

Linear regions of the basic layout can be regions of the basic layout in which straight lines having a predetermined length extend.

Defining the nonlinear regions and linear regions of the basic layout can comprise examining the nonlinear regions using an image tool.

Defining the nonlinear regions and linear regions of the basic layout can comprise examining the linear regions using an image tool.

According to another aspect of the present invention, there is provided an image contour for predicting a semiconductor pattern formed using an SADP (self aligned double patterning) process comprising forming first and second hard mask patterns, comprising: forming a basic layout of the first hard mask pattern; performing an optical proximity effect correction (OPC) on the basic layout to form an OPC layout; defining nonlinear regions and linear regions of the basic layout; emulating the nonlinear regions of the basic layout using the OPC layout to form an image contour of the nonlinear regions; determining the linear regions of the basic layout as an image contour of the linear regions; and combining the image contour of the nonlinear regions and the image contour of the linear regions to form an image contour of the first hard mask pattern of the entire semiconductor device.

The semiconductor device can be a flash memory device. The image contour of the semiconductor device can include a gate pattern.

Linear regions of the basic layout can be regions of the basic layout in which straight lines having a predetermined length extend.

Defining the nonlinear regions and linear regions of the basic layout can comprise examining the nonlinear regions using an image tool.

Defining the nonlinear regions and linear regions of the basic layout can comprise examining the linear regions using an image tool.

The method can further comprise forming an image contour of the second hard mask pattern using the image contour of the first hard mask pattern.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow diagram of a method of forming an image contour according to an embodiment of the present invention; and

FIGS. 2A through 2F are views of T-shape patterns illustrating a method of forming the image contour, according to embodiments of the present invention.

### DETAILED DESCRIPTION OF EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete. In the drawings, the thicknesses of layers and regions are exaggerated for clarity. Like reference numerals in the drawings denote like elements, and thus their description will be omitted.

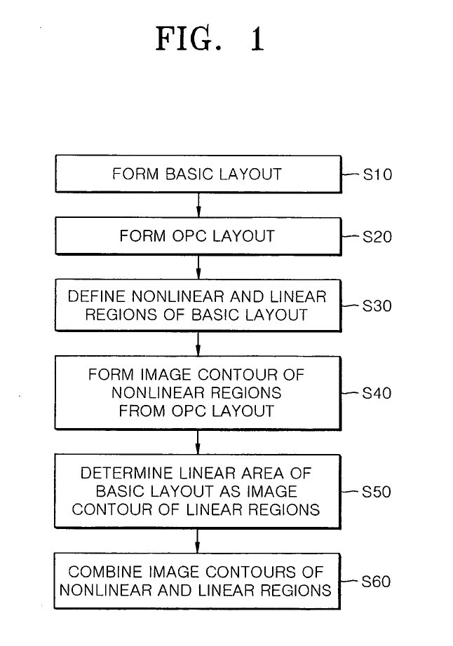

FIG. 1 is a flow diagram of a method of forming an image contour according to an embodiment of the present invention. Referring to FIG. 1, in operation S10, a basic layout is formed from a circuit design of a semiconductor device. The basic layout is formed as a pattern that can be used to realize a circuit of the semiconductor device in a semiconductor fabrication process. In a basic layout, any distortion that can occur to an image of a photo mask pattern caused by when the image is transferred to the wafer by an exposure is not considered.

In operation S20, an optical proximity effect correction (OPC) is performed on the basic layout to form an OPC layout. As a result of performing the OPC, OPC data related to the distortion of a pattern caused by the optical proximity effect can be obtained. The pattern of the basic layout is corrected based on the OPC data to form the OPC layout.

In operation S30, the presence of areas, regions, or portions of the basic layout where the patterns or portions of patterns are not linear, i.e., nonlinear regions, are determined, to define nonlinear regions and linear regions. For example, nonlinear regions of patterns, such as ends or curved parts, can be determined using an appropriate graphic tool. Alternatively, linear regions can be determined from the basic layout to define nonlinear and linear regions.

In operation S40, the nonlinear regions determined above are emulated using the OPC layout to form an image contour of the non-linear regions. While a layout is generally constructed of polygons, an image contour provides curved lines and an outline which is very similar to the eventual image of the pattern.

In operation S50, the linear regions are not emulated using the OPC layout; instead, the linear regions of the basic layout are determined directly as an image contour of the linear regions.

In operation S60, the image contour of the nonlinear regions and the image contour of the linear regions are combined to finally form an image contour of the entire semiconductor chip.

A large amount of time is generally required to extract the image contour of the entire semiconductor chip from the OPC layout. Therefore, for those regions where distortion caused by an optical proximity effect occurs such as the non-linear regions, an image contour can be extracted from an OPC layout, and for the remaining regions such as the linear regions, a basic layout may be determined as an image contour. As a result, the time required to form an image contour of an entire semiconductor chip is considerably reduced.

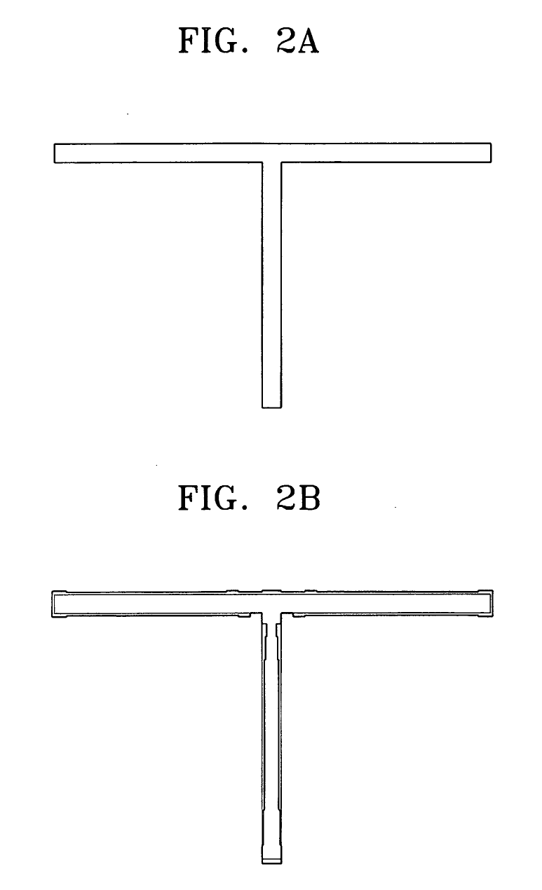

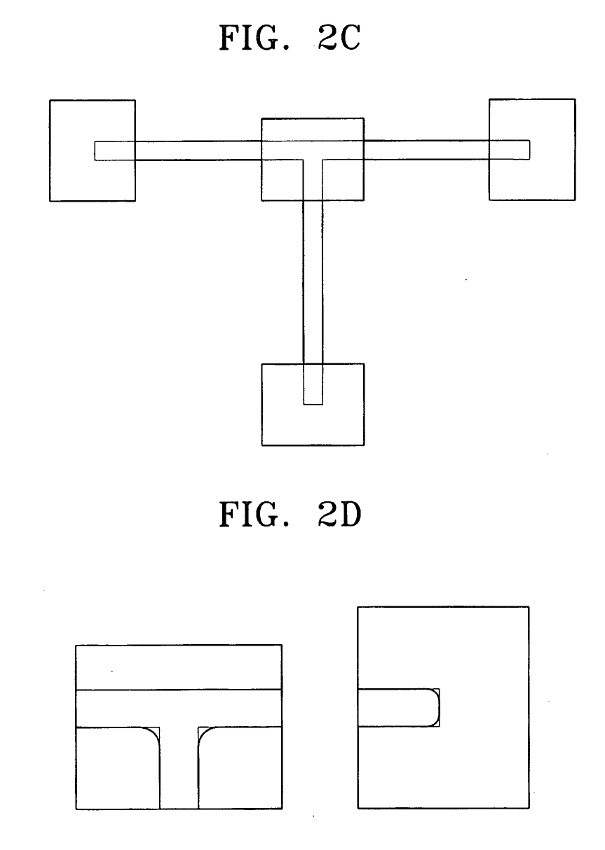

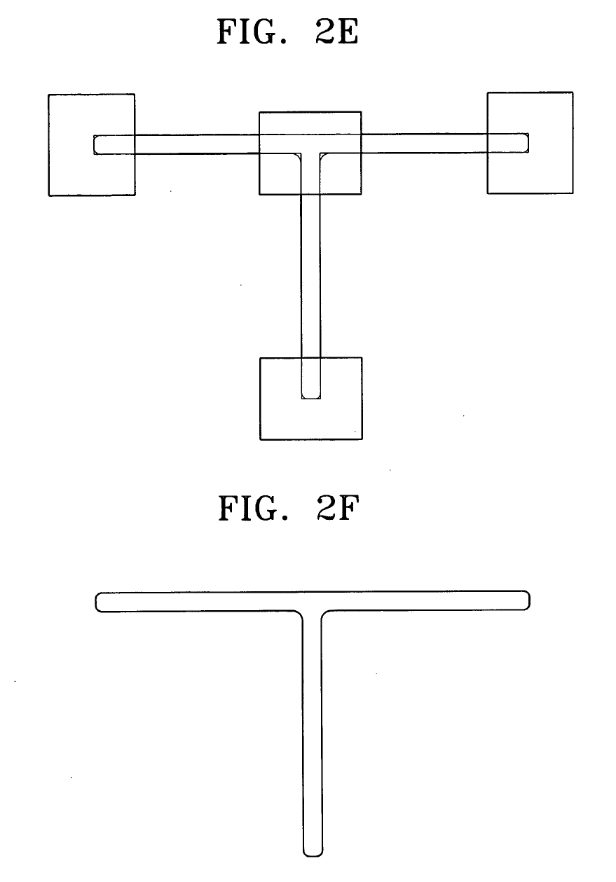

FIGS. 2A through 2F are views illustrating a method of forming an image contour for a T-shape pattern as an example, according to an embodiment of the present invention.

FIG. 2A is a view illustrating a T-shape pattern of a basic layout formed from a circuit design, as an example portion of basic layout. Two straight lines perpendicular to each other meet to form the T-shape pattern of the basic layout, ends of the two straight lines and a portion of the junction at which the two straight lines meet correspond to nonlinear regions, and other regions correspond to linear regions.

FIG. 2B is a view illustrating an OPC layout obtained by performing an OPC on the basic layout illustrated in FIG. 2A. As shown in FIG. 2B, a majority of the straight-line portions of the T-shape pattern of the basic layout are also in a straight-line form in the OPC layout. However, ends of the T-shape pattern and a portion at which the two straight lines meet in the OPC layout are different from those portions in the basic layout.

FIG. 2C is a view illustrating the nonlinear regions of the basic layout illustrated in FIG. 2A. Nonlinear regions, i.e., regions where the patterns or portions of patterns are not linear, can be found using a graphic tool under appropriate conditions. The ranges of the nonlinear regions may be adjusted depending on a shape or size of a pattern.

FIG. 2D is view illustrating an image contour formed by emulating the nonlinear regions of FIG. 2C using the OPC layout of FIG. 2B and a basic layout of the corresponding part. As shown in FIG. 2D, an image contour of the ends of the T-shape pattern and a contact point portion at the intersection of the straight lines of the T-shape pattern has a rounded contour. The image contour that is formed by emulating the nonlinear region using the OPC layout may also be used to determine whether the OPC operation of the OPC layout has achieved appropriate results.

FIG. 2E is a view illustrating a combination of an image contour of the nonlinear region of the T-shape pattern, i.e., the ends and the contact point portions of the T-shape pattern, with a basic layout of linear regions of the T-shape pattern. FIG. 2F is a view illustrating an image contour of the overall T-shape pattern of FIG. 2E. In other words, to form the image contour of the linear region of the T-shaped pattern, the basic layout is adopted as it is, and only regions of the T-shaped pattern where image distortion can occurs in an exposure process, such as the non-linear regions, are emulated using the OPC layout.

In a case where a pattern is to be formed using SADP, an image contour of a first hard mask pattern can be used to predict a second hard mask pattern that is formed based on the first hard mask pattern. If the second hard mask pattern predicted from the image contour of the first hard mask pattern is different from a desired pattern, a thin film deposition process or an etching process used for patterning may be adjusted or a layout of the first hard mask pattern may be changed to obtain the desired pattern. Thus, the time required to form the image contour of the first hard mask pattern can be reduced, to thereby reduce design and processing time.

An image contour can be used to predict a shape of a pattern of a gate of a transistor so as to predict the electrical characteristics of the transistor related to the shape of the pattern of the gate.

In a gate pattern of a flash memory device, the ratio of nonlinear regions of the gate pattern is below 10% relative to the entire gate pattern; a majority of the gate pattern is represented by linear regions. An image contour of the gate pattern of the flash memory can be formed using the method of forming the image contour according to the present invention. As a result, the time required for forming the image contour of the overall device pattern can be drastically reduced.

Accordingly, according to the present invention, a time required to form an image contour of an overall device pattern can be reduced, to thereby reduce TAT for the device.

An image contour formed according to the present invention can be applied, for example, to the formation of flash memory devices and other semiconductor devices. In addition, the image contour according to the present invention can be applied to a gate pattern and to other types of patterns, such as a bit line or metal line.

As described above, in a method of forming an image contour according to the present invention, a layout of a semiconductor device can be divided or partitioned into nonlinear regions and linear regions. The nonlinear regions can be emulated using an OPC layout to form an image contour of nonlinear regions. The linear regions of the basic layout can be used directly to form an image contour of linear regions. The image contours of the nonlinear regions and linear regions are then combined to effectively form an image contour of a pattern of an entire chip within a relatively short time period.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of forming an image contour, comprising:
forming a basic layout for a semiconductor device;
performing an optical proximity effect correction (OPC) on the basic layout to form an OPC layout;
defining nonlinear regions and linear regions of the basic layout;
emulating the nonlinear regions of the basic layout using the OPC layout to form an image contour of the nonlinear regions;
determining the linear regions of the basic layout as an image contour of the linear regions; and
combining the image contour of the nonlinear regions and image contour of the linear regions to form an image contour of the entire semiconductor device.

2. The method of claim 1, wherein the semiconductor device is a flash memory device.

3. The method of claim 2, wherein the image contour of the semiconductor device includes a gate pattern.

4. The method of claim 1, wherein the linear regions of the basic layout are regions of the basic layout in which straight lines having a predetermined length extend.

5. The method of claim 1, wherein defining the nonlinear regions and linear regions of the basic layout comprises examining the nonlinear regions using an image tool.

6. The method of claim 1, wherein defining the nonlinear regions and linear regions of the basic layout comprises examining the linear regions using an image tool.

7. A method of forming an image contour for predicting a semiconductor pattern formed using an SADP (self aligned double patterning) process comprising
forming first and second hard mask patterns, comprising:
forming a basic layout of the first hard mask pattern;
performing an optical proximity effect correction (OPC) on the basic layout to form an OPC layout;
defining nonlinear regions and linear regions of the basic layout;
emulating the nonlinear regions of the basic layout using the OPC layout to form an image contour of the nonlinear regions;
determining the linear regions of the basic layout as an image contour of the linear regions; and
combining the image contour of the nonlinear regions and the image contour of the linear regions to form an image contour of the first hard mask pattern of the entire semiconductor device.

8. The method of claim 7, wherein the semiconductor device is a flash memory device.

9. The method of claim 8, wherein the image contour of the semiconductor device includes a gate pattern.

10. The method of claim 7, wherein the linear regions of the basic layout are regions of the basic layout in which straight lines having a predetermined length extend.

11. The method of claim 7, wherein defining the nonlinear regions and linear regions of the basic layout comprises examining the nonlinear regions using an image tool.

12. The method of claim 7, wherein defining the nonlinear regions and linear regions of the basic layout comprises examining the linear regions using an image tool.

13. The method of claim 7, further comprising forming an image contour of the second hard mask pattern using the image contour of the first hard mask pattern.
